(19) United States
(12) Patent Application Publication
(10) Pub. No.: US 2005/0126673 A1
(43) Pub. Date: Jun. 16, 2005

(54) Pneumatic tire

(75) Inventors: Shinichi Miyazaki, Kobe-shi (JP); Osamu Toda, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd., Kobe-shi (JP)

(21) Appl. No.: 11/049,738

(22) Filed: Feb. 4, 2005

Related U.S. Application Data
(62) Division of application No. 09/853,614, filed on May 14, 2001, now abandoned.

(30) Foreign Application Priority Data
May 30, 2000 (JP) 2000-160497
May 30, 2000 (JP) 2000-160498

(51) Int. Cl. B60C 9/00; D02G 3/48; B29D 30/38

(52) U.S. Cl. 152/527; 152/531; 152/556; 156/133; 156/123; 152/451

(57) ABSTRACT

A pneumatic tire comprises a carcass extending between bead portions through a tread portion and sidewall portions, and a belt disposed radially outside the carcass in the tread portion, wherein at least one of the carcass and the belt is reinforced with aliphatic polyketone fiber cords having specific characteristics.

The present invention relates to a pneumatic tire reinforced with aliphatic polyketone fiber cords.

In general, a pneumatic tire is provided with a carcass and a belt which are reinforced with carcass cords and belt cords, respectively. In case of organic cords, for example, polyester, nylon, and aromatic polyamide are widely used as materials for such tire reinforcing cords.

In order to improve a high speed durability of a passenger car radial tire for example, usually the belt includes a breaker and a band disposed on the radially outside of the breaker, and nylon cords are widely used as the band cords. Further, aromatic polyamide cords are also used. The aromatic polyamide cords are well known as being desirable to accomplish the purpose of the band (namely hooping) because of the excellent strength and high elastic modulus. In case of nylon cord band, when the tire is made to withstand very high speed rotation, the quantity of the nylon cords is inevitably increased. As a result, undesirably the tire weight increases in a radially outermost part of the tire. This problem may be solved by employing an aromatic polyamide cord band. In case of aromatic polyamide cords, however, there is another problem which is a relatively high material cost. Further, the aromatic polyamide cords are relatively weak in fatigue especially bending deformation.

On the other hand, polyester cords are widely employed in the carcass of a passenger car radial tire for example. The polyester cords are poor in adhesion properties to rubber. Therefore, in order to obtain sufficient adhesion to the surrounding rubber, an epoxy dipping process and resorcinol-formaldehyde/latex dipping process are indispensable to the polyester cords. These processes hinder the improvement in the tire production efficiency and a reduction in the tire production cost.

In the laid-open Japanese patent application JP-A-9-324377, an aliphatic polyketone tire cord is disclosed and the use in a carcass of a radial tire is suggested, wherein the tire cord is formed by twisting aliphatic polyketone filaments each having a tensile strength of not less than 10.0 g/d and an initial modulus of not less than 120 g/d, and the twist coefficient is in a range of from 1300 to 2200. As to characteristics of the finished cord, disclosed is only the bending rigidity which is in a range of from 10 to 80 g.

It is therefore, an object of the present invention to provide a pneumatic tire, in which, by employing aliphatic polyketone cords having specific characteristics, the above-mentioned problems are solved.

According to the present invention, a pneumatic tire comprises a carcass extending between bead portions through a tread portion and sidewall portions and a belt disposed radially outside the carcass in the tread portion, and at least one of the carcass and the belt is reinforced with aliphatic polyketone fiber cords.

In case of the belt (band), it is preferable that the aliphatic polyketone fiber cords each have a tensile strength of not less than 9.8 g/d, a standard elongation of not more than 5.0%, and a dry heat shrinkage of not more than 6.0%, and the sum of the standard elongation and the dry heat shrinkage is not more than 9%, and the twist coefficient is in a range of from 1500 to 2000.

In case of the carcass, it is preferable that the aliphatic polyketone fiber carcass cords each have a tensile strength of not less than 15.0 g/d, a standard elongation of not more than 3.0%, and a dry heat shrinkage of not more than 3.0%, and the sum of the standard elongation and the dry heat shrinkage is not more than 5.5%.

Definitions

The tensile strength of a cord is a load at rapture per denier which is measured according to the Japanese Industrial Standard L1017—Testing Methods for Chemical Fiber Tire Cords, 7.—Testing Method, 7.5—Tensile Strength and Elongation Percentage, 7.5.1—Test in Standard Condition.

The standard elongation is an elongation in percent under a load of 2.25 gram/denier which is measured according to the Japanese Industrial Standard L1017—Testing Methods for Chemical Fiber Tire Cords, 7.—Testing Method, 7.7—Elongation Percentage in Constant Load, 7.7.1—Test in Standard Condition.

The dry heat shrinkage is a shrinkage in percent after heating at 180 degrees C. for 30 minutes which is measured according to the Japanese Industrial Standard L1017—Testing Methods for Chemical Fiber Tire Cords, 7.—Testing Method, 7.10-Hot-dry Shrinkage Percentage, 7.10.2—Method B (Hot-dry Shrinkage Percentage after Heating).

The twist coefficient is the product of the square root √D of the total denier number D of the cord multiplied by a cord twist number T (turns pre 10 cm) of the cord.

Embodiments of the present invention will now be described in detail in conjunction with the accompanying drawings.

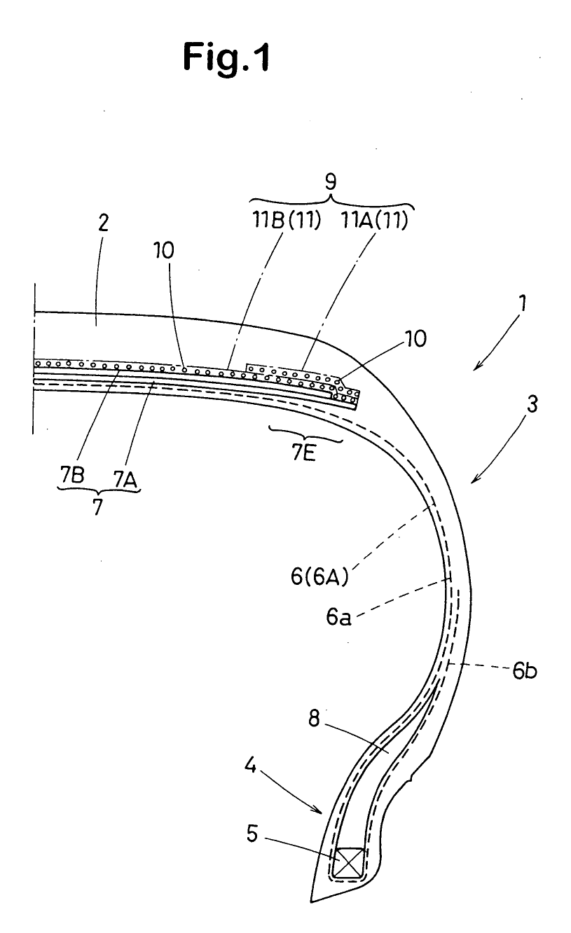

FIG. 1 is a cross sectional view showing a radial tire for passenger cars according to the present invention.

In FIG. 1, the radial tire 1 comprises a tread portion 2, a pair of sidewall portions 3, a pair of bead portions 4, a carcass 6 extending between the bead portions 4, and a belt disposed radially outside the carcass 6 in the tread portion 2.

The carcass 6 comprises at least one ply 6A of carcass cords arranged radially at an angle of from 75 to 90 degrees with respect to the tire circumferential direction. The carcass ply 6A extends between the bead portions 4 through the tread portion 2 and sidewall portions 3 and is turned up around a bead core 5 in each bead portion 4 so as to form a pair of turned up portions 6b and a main portion 6a therebetween.

Each bead portion 4 is provided between the carcass ply main portion 6a and turned up portion 6b with a bead apex 8 made of a hard rubber compound tapering radially outwards from the bead core 5.

The belt can include a breaker 7 disposed on the radially outside of the carcass 6 and a band 9 disposed on the radially outside of the breaker 7. The major difference between the breaker and band is the cord angle.

The breaker 7 comprises at least two cross plies 7A and 7B each made of high modulus breaker cords laid parallel with each other at an angle in the range of from 10 to 35 degrees with respect to the tire circumferential direction. The breaker 7 extends across the substantially entire width of the tread portion 2.

The band 9 comprises at least one layer 11 of band cords 10 whose cord angle is less than 10 degrees, usually not more than 5 degrees, preferably substantially 0 degrees, with respect to the tire circumferential direction. The band 9 extends at least edge portions 7E of the breaker 7 to prevent these portions from being lifted by a centrifugal force during high-speed running. Thus, the band 9 may be (a) a full width band 11B extending across the entire width of the breaker, (b) an edge band 11A extending in the edge portions only, or (c) a combination of the edge band 11A and full width band 11B as shown in FIG. 1. The layer 11 can be made by spirally winding a narrow tape of rubber in which several band cords 10, for example 5 to 15 cords, are embedded along the length thereof. Also the layer 11 can be made by winding one time a wider strip of rubberized cords 10.

According to the present invention, an aliphatic polyketone fiber cord is utilized as tire reinforcing cords such as the carcass cords, belt (breaker, band) cords and the like.

The aliphatic polyketone fiber cord is formed by twisting aliphatic polyketone fibers together at a certain cord twist number T in turns/10 cm. As to the twist structure, a regular lay, Lang's lay, open lay, and compact lay or parallel lay may be utilized. In the following embodiments, a regular lay cord structure is employed. That is, the direction of twist in the strands is opposite to the direction of twist in the cord.

The aliphatic polyketone fiber is made of at least one kind of copolymer consisting of repeated linked units which are alternating carbon monoxide units and olefin units (A) as shown in the following structural formula: 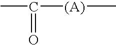
As the olefin units (A), ethylene is mainly used, but it may be possible that other olefins such as propylene, butene, pentene, etc. are included. The mole percentage of ethylene to the total of olefin is not less than 90 molt, preferably not less than 94 molt, more preferably 100 mol %. If less than 90 molt, it is difficult to obtain a strength and tensile elastic modulus which are necessary as the tire reinforcing cord. That is, the aliphatic polyketone fiber is made of a copolymer of carbon monoxide and one kind of olefin (or ethylenee) and optional copolymer(s) of carbon monoxide and two or more kinds of olefins. Preferably, the aliphatic polyketone has the following structure: 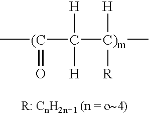
In this example, a copolymer of carbon monoxide and substantially 100% ethylene is used, namely, n=0.

In manufacturing the aliphatic polyketone fibers, it is preferable for environmental and economical aspects to use a melt spinning method.

### EMBODIMENT 1

In this embodiment, an aliphatic polyketone fiber cord is used as the band cords 10.

The aliphatic polyketone fiber cord in the band has a twist coefficient N of from 1500 to 2000, a tensile strength of not less than 9.8 g/d, a standard elongation of not more than 5.0%, and the sum of the standard elongation and dry heat shrinkage is not more than 9%. The dry heat shrinkage is not more than 6.0%. Preferably, the total denier number D of the band cord 10 is in a range of from 2000 to 4500 deniers.

If the tensile strength is less than 9.8 g/d, it is necessary to increase the quantity of the cords in order to maintain the breaking strength of the tire. Accordingly, it becomes difficult to provide a light-weight low-cost tire. That is, it is difficult to take the advantage over the conventional nylon or polyester fiber cords can not.

If the standard elongation is more than 5.0%, and/or the dry heat shrinkage is more than 6.0%, and/or the sum of the standard elongation and dry heat shrinkage is more than 9%, then the band cords have a large elongation due to the internal heat build-up in the tread portion and the centrifugal force during high speed running. In other words, the hooping effect of the band becomes insufficient, and the high-speed durability can not be improved.

If the twist coefficient N is less than 1500, the fatigue resistance and strength of the cord decreases are liable to decrease. If the twist coefficient N is more than 2000, the tensile elastic modulus decreases and the hooping effect of the band decreases and the high-speed durability can not be improved. As described above, a regular lay cord structure is used in this embodiment. However, a parallel lay cord structure may be employed in the aliphatic polyketone fiber band cord to further reduce the quantity and thereby to reduce the weight and cost. In this case, the twist coefficient N may be set in a range of from 150 to 750.

On the other hand, the breaker in this example is made of steel cords. But, high modulus organic fiber cords such as aromatic polyamide fiber cords, aromatic polyester fiber cords and the like, or the aliphatic polyketone fiber cords may be also used.

The carcass in this example is made of polyester fiber cords. However, other organic fiber cords, e.g. nylon, rayon, aromatic polyamide, aliphatic polyketone and the like, and further steel cords may be used according to the use, size, etc.

Comparison Test 1

Test tires of size P165/70R13 having the structure shown in FIG. 1 and specifications shown in Table 1 were made and tested for high-speed durability.

(1) High-Speed Durability Test

Using a tire test drum, the test tire mounted on a standard wheel rim (size 5JX13), inflated to a standard pressure of 280 kPa, and loaded with a normal load of 437 kgf which is 80% of the maximum pressure which are specified by Japan Automobile Tire Manufacturers Association was run at an ambient temperature of 25 plus/minus 5 degrees C. The running speed was increased every ten minutes at a step of 10 km/h from 170 km/h. The running was continued until any damage occurred and the running distance was measured. The results are indicated by an index based on Ref.A1 being 100, wherein the larger the index number, the better the high-speed durability.

TABLE 1

| Tire | Ref. A1 | Ref. A2 | Ex. A1 |
|---|---|---|---|
| Band | | | |
| Cord | aromatic | nylon 66 | aliphatic |
| | polyamide | | polyketone* |
| | 1500 d/2 | 1500 d/2 | 1500 d/2 |
| Total denier D | 3000 | 3000 | 3000 |
| Twist T (turns/10 cm) | 30 | 30 | 30 |
| Twist coefficient N | 1643 | 1643 | 1643 |
| Tensile strength (g/d) | 17.3 | 8 | 13.3 |
| Standard elongation (%) | 0.9 | 12.7 | 3.8 |
| Dry-heat shrinkage (%) | 0 | 5 | 1.8 |
| Sum (%) | 0.9 | 17.7 | 5.6 |
| Cord count/5 cm | 30 | 49 | 40 |
| Material cost | high | low | low |
| Breaker | | | |
| Cord | steel | steel | steel |
| | 1 × 1 × 0.42 | 1 × 1 × 0.42 | 1 × 1 × 0.42 |
| No. of ply | 2 | 2 | 2 |
| Cord count/5 cm | 40 | 40 | 40 |
| Cord angle (deg.) | −1 | −1 | −1 |
| Carcass | | | |
| Cord | polyester | polyester | polyester |
| | 1500 d/2 | 1500 d/2 | 1500 d/2 |
| Cord count/5 cm | 50 | 50 | 50 |
| No. of ply | 1 | 1 | 1 |
| Cord angle (deg.) | 90 | 90 | 90 |
| High-speed durability | 101 | 100 | 106 |

*a copolymer of ethylene and carbon monoxide (ethylene was almost 100 mol %)

From the test results, it was confirmed that, by using the aliphatic polyketone fiber cords in the band, the high-speed durability can be improved more than the aromatic polyamide fiber cord, without increasing the cost.

### EMBODIMENT 2

In this embodiment, an aliphatic polyketone fiber cord is utilized as the carcass cords.

The aliphatic polyketone fiber cord in the carcass has a tensile strength of not less than 15.0 g/d, a standard elongation of not more than 3.0%, and a dry heat shrinkage of not more than 3.0%, and the sum of the standard elongation and dry heat shrinkage is not more than 5.5%. The total denier number D of the carcass cord is in a rage of from 2000 to 4500 deniers. The twist coefficient N of the carcass cord is in a range of from 1000 to 2500. The cord count of the carcass ply is in a range of from 30 to 50/5 cm width.

By setting the tensile strength in the range of not less than 15.0 g/d, the strength of the carcass 6 is improved. Further, as the specific gravity is 1.24 which is less than the specific gravity (=1.38) of polyester, a corresponding weight reduction may be possible. Further, the weight reduction can be achieved by decreasing the cord count of the carcass and/or the total denier number of the cord in comparison with the polyester cord, while maintaining the strength. And the fuel consumption is improved. If the tensile strength is less than 15.0 g/d, these advantageous effects can not be obtained.

By setting the standard elongation in the range of not more than 3.0%, the tire rigidity is improved or maintained and the steering stability is improved. Further, a growth in the tire diameter due to high speed rotation is controlled and the high-speed durability is improved.

If the dry heat shrinkage is more than 3.0%, or if the sum of the standard elongation and dry heat shrinkage is more than 5.5%, the tire shrinks after the vulcanization, and the tire uniformity is disturbed. Therefore, in order to avoid this drawback, so called post cure inflation (PCI) is necessitated. That is, after the vulcanized mold is took out from the mold, it is necessary to inflate the tire to a higher pressure than the atmosphere pressure for a certain time so that the tire gets cold to prevent the shrinkage of the carcass cords and the resultant deformation. Accordingly, the production efficiency decreases and production cost increases.

As the aliphatic polyketone fiber cord has a high strength and a high modulus, the cord count (30 to 50/5 cm) can be decreased in comparison with the cord count (45 to 55/5 cm) in the polyester fiber cord. Thus, the tire weight can be decreased. If the cord count is less than 30/5 cm, the strength of the carcass 6 is lowered. If more than 50/5 cm, the rubber between the cords becomes short, and adhesive failure between the cords and rubber is liable to occur.

If the twist coefficient N is less than 1000, the fatigue resistance and strength of the cord decreases are liable to decrease. If the twist coefficient N is more than 2500, the tensile elastic modulus decreases and the tire rigidity decreases and the steering stability and high-speed durability can not be improved.

If the total denier number D is less than 2000 deniers, it is necessary to in crease the cord count which decreases the production efficiency. If more than 4500 deniers, the resistance to external injure decreases and the tire weight increases.

In this embodiment, in addition to the carcass, aliphatic polyketone fiber cords are employed in the belt. The belt in this example consists of the breaker 7, and at least one of the breaker plies 7A and 7B, for example the radially inner breaker ply 7A is made of aliphatic polyketone fiber cords but the radially outer breaker ply 7B is made of steel cords. From a point of view of the puncture resistance, it may be preferable that the radially outermost ply is a steel cord ply rather than an aliphatic polyketone fiber cord ply.

The aliphatic polyketone fiber cord used in the breaker has a tensile strength of not less than 15.0 g/d, a standard elongation of not more than 3.0%, and a dry heat shrinkage of not more than 3.0%. The total denier number D is in a range of from 2000 to 4500 deniers. The twist coefficient N is in a range of from 1000 to 2500. The sum of the standard elongation and dry heat shrinkage is not more than 5.5%. In this example, a cord identical with the carcass cord is used in the breaker.

As the aliphatic polyketone fiber cords are used in both of the carcass and breaker, a remarkable weight reduction is possible. Further, a sharing stress between the carcass ply and breaker ply is mitigated to prevent breaker edge separation. The improvements in the high-speed durability, steering stability and ride comfort due to the use of the aliphatic polyketone fiber cords in the carcass may be further promoted.

Comparison Test 2

Test tires of size P165/70R13 having the structure shown in FIG. 1 and specifications shown in Table 2 were made and tested as follows.

(1) High-Speed Durability Test

Same as above.

(2) Steering Stability and Ride Comfort Test.

During running a 1600 cc FF passenger car provided on all the four wheels with the test tires, the steering stability and ride comfort were evaluated by the test driver into five ranks (Ref.B1=3) wherein the larger the rank number, the better the performance.

TABLE 2

| Tire | Ref. B1 | Ex. B1 | Ex. B2 | Ex. B3 |
|---|---|---|---|---|
| Carcass | | | | |
| Cord | polyester | aliphatic polyketone* | aliphatic polyketone* | aliphatic polyketone* |
| | 1500 d/2 | 1500 d/2 | 1500 d/2 | 1500 d/2 |
| Total denier D | 3000 | 3000 | 3000 | 3000 |
| Twist coefficient N | 1643 | 1643 | 1643 | 1643 |
| Tensile strength (g/d) | 7.8 | 16.8 | 16.8 | 16.8 |
| Standard elongation (%) | 4.5 | 2 | 2 | 2 |
| Dry-heat shrinkage (%) | 3.5 | 1.5 | 1.5 | 1.5 |
| Elongation + Shrikage (%) | 8 | 3.5 | 3.5 | 3.5 |
| Cord count (/5 cm) | 50 | 40 | 40 | 40 |
| Number of ply | 1 | 1 | 1 | 1 |
| Cord angle (deg.) | 89 | 89 | 89 | 89 |
| Breaker | | | | |
| Outer ply | | | | |
| Cord | steel | steel | steel | steel |
| | 1 × 3 × 0.27 | 1 × 3 × 0.27 | 1 × 3 × 0.27 | 1 × 3 × 0.27 |
| Cord count (/5 cm) | 40 | 40 | 40 | 40 |
| Cord angle (deg.) | 20 | 20 | 20 | 20 |
| Inner ply | | | | |
| Cord | steel | steel | steel | aliphatic polyketone* |
| | 1 × 3 × 0.27 | 1 × 3 × 0.27 | 1 × 3 × 0.27 | 1500 d/2 |
| | | | | same as carcass |
| Core count (/5 cm) | 40 | 40 | 40 | 40 |
| Cord angle (deg.) | −20 | −20 | −20 | −20 |
| Tire weight difference (g) | 0 | −106 | −106 | −132 |
| Material cost** | C | B | B | A |
| High-speed durability | 100 | 105 | 106 | 104 |
| Steering stability | 3 | 3.4 | 3.4 | 3.3 |
| Ride comfort | 3 | 3.1 | 3.1 | 3.3 |
| Fuel consumption** | C | B | B | A |
| PCI*** | R | N | R | N |

*a copolymer of ethylene and carbon monoxide (ethylene was almost 100 mol %)
**good <- A, B, C -> poor
***Necessity of post cure inflation, R: necessary, N: not necessary

It was confirmed from the test results that, by using the aliphatic polyketone fiber cord in the carcass, the high-speed durability, steering stability, ride comfort and the like can be improved while achieving a weight reduction and a cost reduction.

1. A pneumatic tire comprising
a tread portion,
a pair of sidewall portions,
a pair of bead portions,
a carcass ply of cords extending between the bead portions through the tread portion and sidewall portions,
a breaker ply disposed radially outside the carcass ply and made of cords laid at an angle of from 10 to 35 degrees with respect to the circumferential direction of the tire,
a band ply disposed radially outside the breaker ply and made of cords whose cord angles are not more than 5 degrees with respect to the tire circumferential direction,
wherein said cords of the band ply are aliphatic polyketone fiber cords each having a tensile strength of not less than 9.8 g/d, a standard elongation of not more than 5.0%, and a dry heat shrinkage of not more than 6.0%, wherein the sum of the standard elongation and the dry heat shrinkage is not more than 9%, a twist coefficient N is in a range of from 1500 to 2000, the twist coefficient N is the product (Tx√D) of the square root of a total denier number D of the cord and the twist number T (turns/10 cm) of the cord, and
said cords of the breaker ply are steel cords,
said cords of the carcass ply are aliphatic polyketone fiber cords each having a tensile strength of not less than 15.0 g/d, a standard elongation of not more than 3.0%, and
a dry heat shrinkage of not more than 3.0%, wherein the sum of the standard elongation and the dry heat shrinkage is not more than 5.5%.

2. A pneumatic tire comprising
a tread portion,
a pair of sidewall portions,
a pair of bead portions,
a carcass ply of cords extending between the bead portions through the tread portion and sidewall portions,
a breaker ply disposed radially outside the carcass ply and made of cords laid at an angle of from 10 to 35 degrees with respect to the circumferential direction of the tire,
a band ply disposed radially outside the breaker ply and made of cords whose cord angles are not more than 5 degrees with respect to the tire circumferential direction,
wherein said cords of the band ply are aliphatic polyketone fiber cords each having a tensile strength of not less than 9.8 g/d, a standard elongation of not more than 5.0%, and a dry heat shrinkage of not more than 6.0%, wherein the sum of the standard elongation and the dry heat shrinkage is not more than 9%, a twist coefficient N is in a range of from 1500 to 2000, the twist coefficient N is the product (Tx√D) of the square root of a total denier number D of the cord and the twist number T (turns/10 cm) of the cord, and
said cords of the carcass ply are aliphatic polyketone fiber cords each having a tensile strength of not less than 15.0 g/d, a standard elongation of not more than 3.0%, and
a dry heat shrinkage of not more than 3.0%, wherein the sum of the standard elongation and the dry heat shrinkage is not more than 5.5%,
said cords of the breaker ply are aliphatic polyketone fiber cord each having a tensile strength of not less than 15.0 g/d, a standard elongation of not more than 3.0%, and
a dry heat shrinkage of not more than 3.0%, wherein the sum of the standard elongation and dry heat shrinkage is not more than 5.5%,
the total denier number of the cord is in a range of from 2000 to 4500 deniers, and
the twist coefficient is in a range of from 1000 to 2500.

3. The pneumatic tire according to in claim 1, wherein the aliphatic polyketone fiber carcass cords each have a total denier number D in a range of from 2000 to 4500 deniers, and a twist coefficient N is in a range of from 1000 to 2500, the twist coefficient N is the product (Tx√D) of the square root of the total denier number D and the twist number T (turns/10 cm) of the cord.

4. The pneumatic tire according to in claim 2, wherein the aliphatic polyketone fiber carcass cords each have a total denier number D in a range of from 2000 to 4500 deniers, and a twist coefficient N is in a range of from 1000 to 2500, the twist coefficient N is the product (Tx√D) of the square root of the total denier number D and the twist number T (turns/10 cm) of the cord.

5. A method of making a pneumatic tire provided with a carcass ply made of aliphatic polyketone fiber cords,
selecting a tensile strength from a range of not less than 15.0 g/d for the aliphatic polyketone fiber cords,
selecting a standard elongation from a range of not more than 3.0% and a dry heat shrinkage from a range of not more than 3.0% for the aliphatic polyketone fiber cords while checking the sum of the standard elongation and the dry heat shrinkage so that the sum is not more than 5.5%,
selecting a total denier number D per aliphatic polyketone fiber cord from a range of 2000 to 4500 deniers and a twist number T (turns/10 cm) of the cord while checking the product (Tx√D) of the square root of the total denier number D and the twist number T so that the product (Tx√D) ranges from 1000 to 2500,
forming the carcass ply by using the aliphatic polyketone fiber cords.

6. A method according to claim 5, wherein the pneumatic tire further comprises a breaker ply made of aliphatic polyketone fiber cords laid at an angle of from 10 to 35 degrees with respect to the circumferential direction of the tire, and
the method further comprises selecting a tensile strength from a range of not less than 15.0 g/d for the aliphatic polyketone fiber cords of the breaker,
selecting a standard elongation from a range of not more than 3.0% and a dry heat shrinkage from a range of not more than 3.0% for the aliphatic polyketone fiber cords of the breaker while checking the sum of the standard elongation and the dry heat shrinkage so that the sum is not more than 5.5%,
selecting a total denier number D per aliphatic polyketone fiber cord of the breaker from a range of 2000 to 4500 deniers,
selecting a twist number T (turns/7.0 cm) of the aliphatic polyketone fiber cords of the breaker from a range of 1000 to 2500, and
forming the breaker ply by using the aliphatic polyketone fiber cords.
